(19) United States
(12) Patent Application Publication
(10) Pub. No.: US 2008/0088156 A1
(43) Pub. Date: Apr. 17, 2008

(54) Vehicle body structure

(75) Inventors: Kenji Sato, Ichinomiya-shi (JP); Fumihiko Kishima, Konan-shi (JP); Takashi Mogami, Okazaki-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/902,619

(22) Filed: Sep. 24, 2007

(30) Foreign Application Priority Data
Oct. 13, 2006 (JP) 2006-280445

(51) Int. Cl. B62D 25/04

(52) U.S. Cl. 296/203.02

(57) ABSTRACT

Disclosed is a vehicle body structure in which a front pillar, whose cross-section in a direction orthogonal to a longitudinal direction is a closed cross-section, is disposed at each of both vehicle transverse direction end portions of a vehicle cabin front portion such that a longitudinal direction of the front pillar runs along a vehicle up-down direction. A pillar garnish which covers the front pillar is provided at a vehicle cabin inner side of the front pillar. A reinforcing member, which extends in the vehicle up-down direction along the front pillar, is provided between the front pillar and the pillar garnish.

### CROSS-REFERENCE TO RELATED APPLICATION

This application claims priority under 35 USC 119 from Japanese Patent Application No. 2006-280445 filed Oct. 13, 2006, the disclosure of which is incorporated by reference herein.

### BACKGROUND

1. Technical Field

The present invention relates to a body structure of a vehicle such as an automobile or the like, and in particular, relates to a body structure of a vehicle which has front pillars at both vehicle transverse direction end portions of the front portion of the vehicle cabin.

2. Related Art

There has conventionally been known a body structure of a vehicle which has front pillar portions at both vehicle transverse direction end portions of the front portion of the vehicle cabin. In this technique, the rigidity and the strength of the front pillar portion are increased by extending a reinforcing plate and a reinforcing pipe from the top end to the bottom end of the front pillar (see, for example, Japanese Patent Application Laid-Open (JP-A) No. 2001-163252).

However, in the vehicle body structure disclosed in JP-A No. 2001-163252, the reinforcing plate and the reinforcing pipe are provided between a reinforcing member and the inner frame of the front pillar, and the reinforcing plate and the reinforcing pipe are disposed at the interior of the cross-section of the front pillar. As a result, the cross-section of the front pillar must be made to be large in order to increase the cross-sectional secondary moment of the front pillar portion.

### SUMMARY

In view of the aforementioned, the present invention provides a vehicle body structure which can ensure the rigidity and strength of the front pillar portions, without making the cross-sections of the front pillars large.

A first aspect of the present invention provides a vehicle body structure which includes: a front pillar disposed at each of both vehicle transverse direction end portions of a vehicle cabin front portion such that a longitudinal direction of the front pillar runs along a vehicle up-down direction, a cross-section of the front pillar in a direction orthogonal to the longitudinal direction being a closed cross-section; a pillar garnish provided at a vehicle cabin inner side of the front pillar, and covering the front pillar; and a reinforcing member provided between the front pillar and the pillar garnish, and extending in the vehicle up-down direction along the front pillar.

The reinforcing member, which extends in the vehicle up-down direction along the front pillar, is provided between the front pillar, which is disposed at each of both vehicle transverse direction end portions of the vehicle cabin front portion such that the longitudinal direction of the front pillar runs along the vehicle up-down direction and whose cross-section in a direction orthogonal to the longitudinal direction is a closed cross-section, and the pillar garnish which is provided at the vehicle cabin inner side of the front pillar and covers the front pillar. Namely, the reinforcing member is provided outside of the closed cross-section of the front pillar. Therefore, the cross-sectional secondary moment of the front pillar portion of the vehicle is increased by the reinforcing member and the closed cross-section of the front pillar. Thus, the rigidity and strength of the front pillar portion are ensured even if the closed cross-section of the front pillar is not made to be large.

According to a second aspect of the present invention, in the vehicle body structure in accordance with the first aspect of the present invention, the reinforcing member is provided at a side near a front windshield glass, between the front pillar and the pillar garnish.

Since the reinforcing member is provided at the side near the front windshield glass between the front pillar and the pillar garnish, the spacing between the reinforcing member and a vehicle occupant who is seated in the front seat is increased. As a result, there is no likelihood that a vehicle occupant seated in the front seat hits the reinforcing member since the pillar garnish is interposed therebetween.

According to a third aspect of the present invention, in the vehicle body structure in accordance with the first aspect or the second aspect of the present invention, the reinforcing member has a front roof header which is disposed at an upper end portion of the vehicle cabin front portion such that a longitudinal direction of the front roof header runs along a vehicle transverse direction, and which connects upper end portions of the left and right front pillars together, and upper ends of the reinforcing members are one of joined to and disposed near to both vehicle transverse direction end portions of the front roof header.

The front roof header is disposed at the upper end of the vehicle cabin front portion such that the longitudinal direction of the front roof header runs along the vehicle transverse direction. The front roof header connects together the upper end portions of the left and right front pillars. Further, the upper ends of the reinforcing members are joined to or are disposed near to the both vehicle transverse direction end portions of the front roof header. Therefore, if the front roof header attempts to deform toward the rear of the vehicle, deformation of the front roof header toward the rear of the vehicle can be suppressed by the reinforcing members whose upper ends are joined to or are near to the both vehicle transverse direction end portions of the front roof header.

From the above description, it can be understood that, in the structure in accordance with the first aspect of the present invention, the rigidity and strength of the front pillar portion can be ensured without making the cross-section of the front pillar large, and, in the structure in accordance with the second aspect of the present invention, it is possible to prevent a vehicle occupant, who is seated in the front seat, from hitting the reinforcing member since the pillar garnish is interposed therebetween, and, in the structure in accordance with the third aspect of the present invention, deformation of the front roof header can be suppressed.

Other aspects, features and advantages of the present invention will become apparent from the following description taken in conjunction with the accompanying drawings.

### BRIEF DESCRIPTION OF THE DRAWINGS

FIG. 1 is an enlarged cross-sectional view along cross-section line 1-1 of FIG. 6.

FIG. 2 is an enlarged cross-sectional view along cross-section line 2-2 of FIG. 3.

FIG. 3 is a perspective view, as seen obliquely from the front and the vehicle transverse direction inner side, of a portion of a vehicle body structure relating to a first exemplary embodiment of the present invention.

FIG. 4 is a perspective view, as seen obliquely from the front and the vehicle transverse direction inner side, showing the vehicle body structure according to a first exemplary embodiment of the present invention.

FIG. 5 is an exploded perspective view, as seen obliquely from the front and the vehicle transverse direction inner side, showing the vehicle body structure according to a first exemplary embodiment of the present invention.

FIG. 6 is a perspective view, as seen obliquely from the front, showing a vehicle to which the vehicle body structure according to a first exemplary embodiment of the present invention is applied.

FIG. 7 is a cross-sectional view corresponding to FIG. 1 and showing a vehicle body structure according to a second exemplary embodiment of the present invention.

FIG. 8 is a cross-sectional view corresponding to FIG. 1 and showing a vehicle body structure according to a third exemplary embodiment of the present invention.

FIG. 9 is a cross-sectional view corresponding to FIG. 2 and showing a vehicle body structure according to a fourth exemplary embodiment of the present invention.

FIG. 10 is a cross-sectional view corresponding to FIG. 2 and showing a vehicle body structure according to a fifth exemplary embodiment of the present invention.

### DETAILED DESCRIPTION

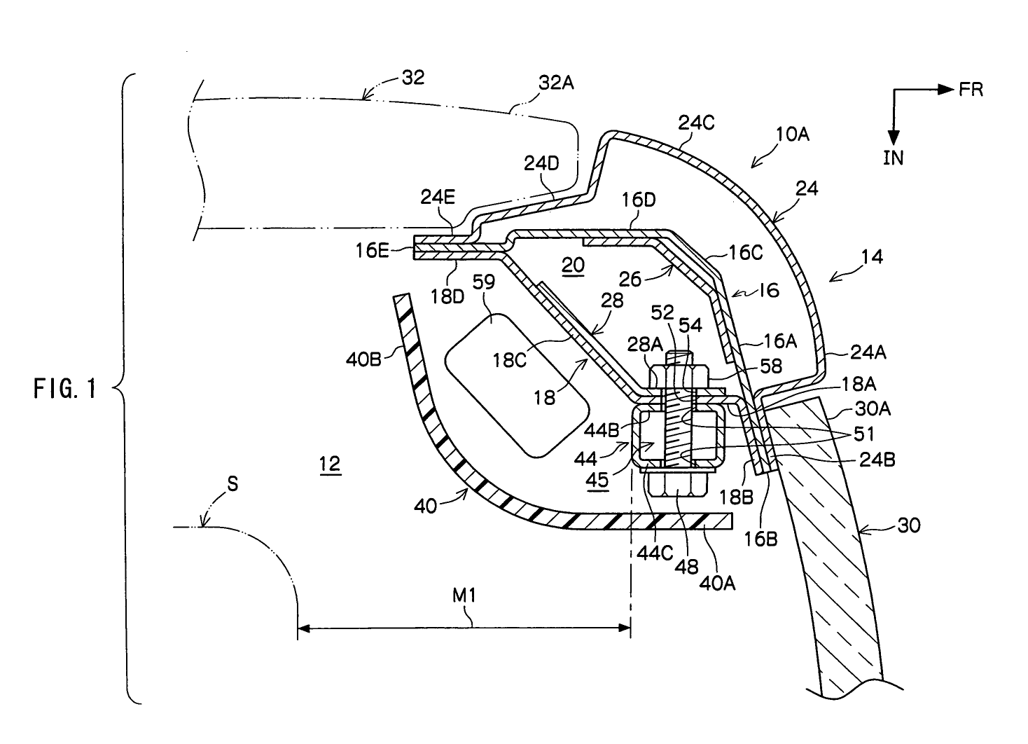

A vehicle body structure relating to a first exemplary embodiment of the present invention will be described with reference to FIG. 1 through FIG. 6.

Note that arrow UP in the drawings indicates the upward direction of the vehicle, arrow FR in the drawings indicates the frontward direction of the vehicle, and arrow IN indicates the direction inward in the transverse direction of the vehicle.

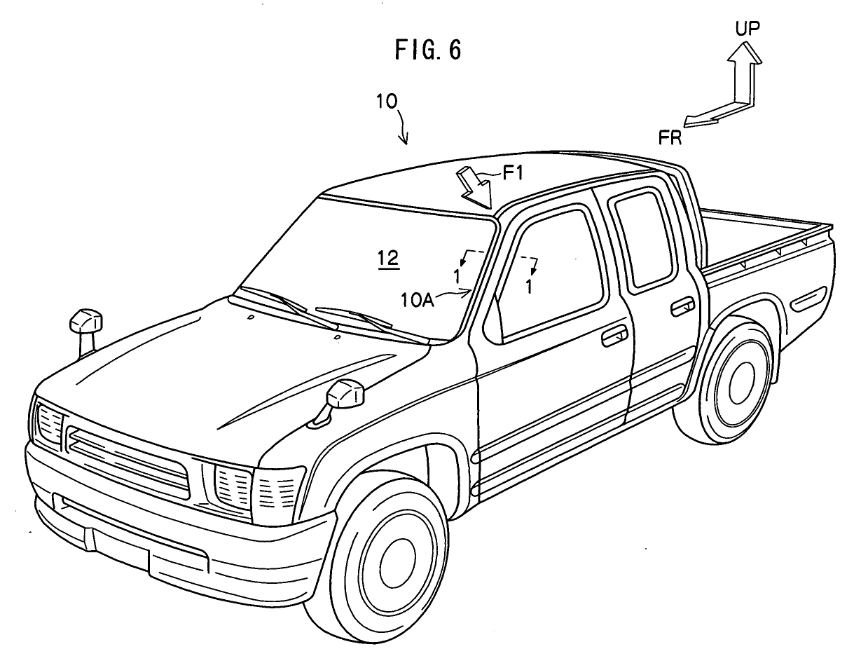

A vehicle, to which the vehicle body structure in accordance with the first exemplary embodiment of the present invention is applied, is shown in FIG. 6 in a perspective view seen obliquely from the front of the vehicle.

As shown in FIG. 6, in a vehicle body 10 of a pick-up truck which serves as the vehicle of the present exemplary embodiment, front pillar (A pillar) portions 10A are provided at both vehicle transverse direction end portions of the front portion of a passenger cabin (vehicle cabin) 12, such that the longitudinal directions of the front pillar portions 10A run along the vehicle up-down direction. The front pillar portion 10A is structured from a front pillar, a front pillar garnish, and the like which will be described later.

An enlarged cross-sectional view along cross-section line 1-1 of FIG. 6 is shown in FIG. 1.

As shown in FIG. 1, a front pillar 14, which structures a portion of the front pillar portion 10A, has a front pillar outer 16, which is formed by a plate member and structures the vehicle body outer side portion of the front pillar 14, and a front pillar inner 18, which is formed by a plate member structuring the vehicle body inner side portion of the front pillar 14.

A flange 18B, which is formed toward the vehicle transverse direction inner side at the front end portion of an inner wall portion 18A of the front pillar inner 18, is joined by welding or the like to a vehicle transverse direction inner side end portion 16B of a front wall portion 16A of the front pillar outer 16. Further, an inclined portion 16C, which is inclined from the vehicle transverse direction inner side front toward the vehicle transverse direction outer side rear, is formed from the vehicle transverse direction outer side end of the front wall portion 16A of the front pillar outer 16. An outer wall portion 16D is formed toward the rear of the vehicle from the rear end of the inclined portion 16C.

An inclined portion 18C, which is inclined from the vehicle transverse direction inner side front toward the vehicle transverse direction outer side rear, is formed from the rear end of the inner wall portion 18A of the front pillar inner 18. A flange 18D is formed toward the rear of the vehicle from the rear end of the inclined portion 18C. The flange 18D of the front pillar inner 18 is joined by welding or the like to a flange 16E which is formed toward the rear of the vehicle at the rear end portion of the outer wall portion 16D of the front pillar outer 16.

Accordingly, the front pillars 14 are disposed at the both vehicle transverse direction end portions of the front portion of the vehicle cabin 12, such that the longitudinal directions of the front pillars 14 run along the vehicle up-down direction. The cross-section of the front pillar 14, in a direction orthogonal to the longitudinal direction thereof, is a closed cross-section 20 due to the front pillar outer 16 and the front pillar inner 18.

Note that the term “closed cross-section” is used herein to mean a cross-sectional structure which is highly-rigid and high-strength and in which the outer peripheral portion of the opening of the cross-section which is the object is substantially continuous. Further, note that the term “substantially” is used herein to mean that a structure is included in which, even if a hole or the like whose cross section is small as compared with the outer peripheral length are formed locally, no such hole or the like exists and the member at the periphery of the opening portion is continuous as viewed in the direction orthogonal to the cross-section (at the near side or far side in the drawing in the case of the front pillar 14 shown in FIG. 1),

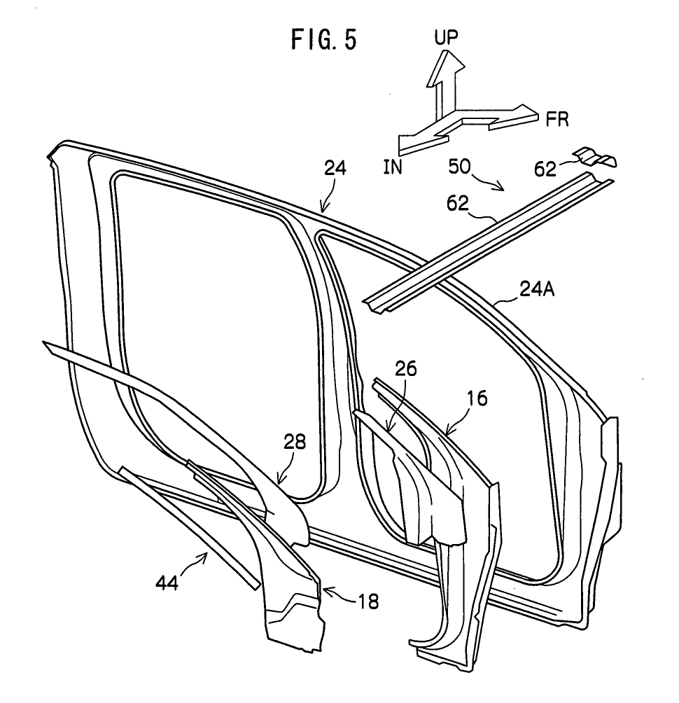

The vehicle transverse direction outer side portion of the vehicle body 10 is shown in FIG. 5 in an exploded perspective view seen obliquely from the front and the vehicle transverse direction inner side.

The vehicle transverse direction outer side portion of the vehicle body 10 is structured by a side member outer 24. A front pillar portion or front wall portion 24A of the side member outer 24 covers the front pillar outer 16 from the outer side of the vehicle body. Further, a front pillar outer reinforcement 26 is disposed at the vehicle body inner side of the front pillar outer 16, along the front pillar outer 16. A front pillar inner reinforcement 28 is disposed at the vehicle body outer side of the front pillar inner 18, along the front pillar inner 18.

As shown in FIG. 1, a step portion 24B, which is concave toward the rear of the vehicle, is formed in the vehicle transverse direction inner side end portion of the front wall portion 24A of the side member outer 24. The rear surface of the step portion 24B is joined by welding or the like to the front surface of the vehicle transverse direction inner side end portion 16B of the front wall portion 16A at the front pillar outer 16. Note that a vehicle transverse direction end portion 30A of a front windshield glass 30 is supported at the front surface of the step portion 24B of the side member outer 24.

A step portion 24D, which is concave toward the vehicle transverse direction inner side, is formed at the rear end portion of an outer wall portion 24C of the side member outer 24. The vehicle transverse direction inner side surface of a flange 24E formed at the rear end of the step portion 24D is joined by welding or the like to the vehicle transverse direction outer side surface of the flange 16E of the front pillar outer 16. Note that a front portion 32A of a front side door 32 is provided at the vehicle transverse direction outer side portion of the step portion 24D of the side member outer 24.

The front pillar outer reinforcement 26 is structured by a plate member which is bent along the front wall portion 16A, the inclined portion 16C, and the outer wall portion 16D of the front pillar outer 16. The front pillar outer reinforcement 26 is joined by welding or the like to the front wall portion 16A, the inclined portion 16C, and the outer wall portion 16D of the front pillar outer 16. Further, the front pillar inner reinforcement 28 is structured by a plate member which is bent along the inner wall portion 18A and the inclined portion 18C of the front pillar inner 18. The front pillar inner reinforcement 28 is joined by welding or the like to the inner wall portion 18A and the inclined portion 18C of the front pillar inner 18.

A front pillar garnish 40, which is formed from a resin material, is disposed in the vehicle up-down direction along the front pillar inner 18 at the vehicle cabin 12 side of the front pillar inner 18, and covers the front pillar inner 18 from the inner side of the vehicle cabin 12. To explain more concretely, the cross-sectional configuration of the front pillar garnish 40 as seen from the vehicle up-down direction is curved in a substantial L-shape. A front portion 40A of the front pillar garnish 40 covers the front pillar inner 18 from the vehicle transverse direction inner side, and a rear portion 40B of the front pillar garnish 40 covers the front pillar inner 18 from the vehicle rear side.

A gap is formed between the front portion 40A of the front pillar garnish 40 and the inner wall portion 18A of the front pillar inner 18. A front pillar reinforcing member 44 is disposed as a reinforcing member between the front portion 40A of the front pillar garnish 40 and the inner wall portion 18A of the front pillar inner 18.

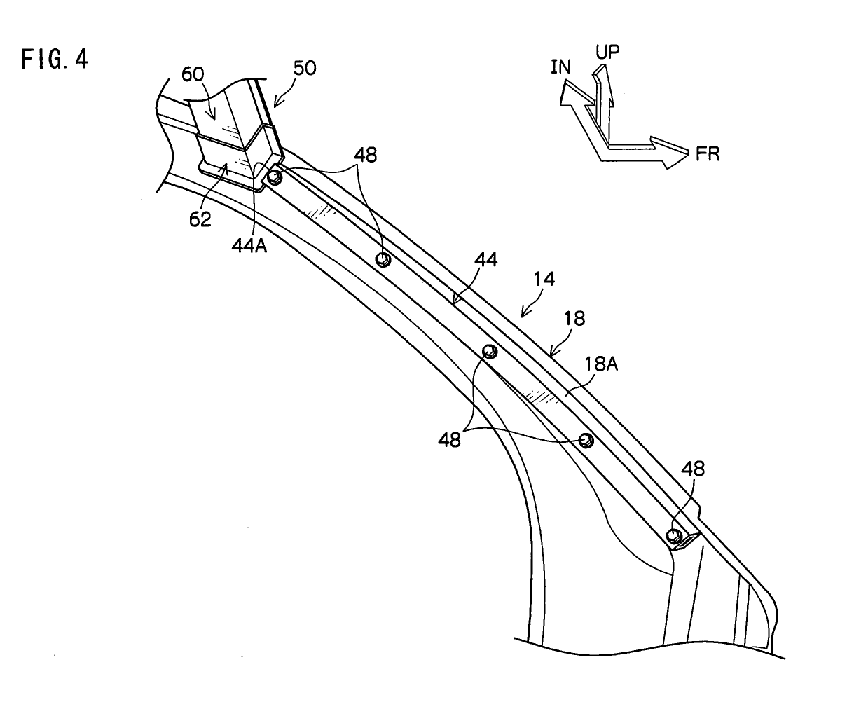

The front pillar 14 and the front pillar reinforcing member 44 are shown in FIG. 4 in a perspective view seen obliquely from the front and the vehicle transverse direction inner side.

As shown in FIG. 4, the front pillar reinforcing member 44 extends in the vehicle up-down direction along the front pillar inner 18. More specifically, the front pillar reinforcing member 44 extends along the front pillar inner 18 from the vehicle front side lower portion toward the vehicle rear side upper portion. An upper end portion 44A of the front pillar reinforcing member 44 reaches a vicinity of the joined portion of the front pillar 14 and a front roof header 50.

Although not illustrated, the lower end portion of the front pillar reinforcing member 44 reaches (and is preferably fixed to) the rear end portion of an apron upper member and a vehicle transverse direction end portion of a cowl panel.

Further, the front pillar reinforcing member 44 is mounted to the front pillar inner 18 by fastening members 48 such as bolts or the like which are provided at predetermined intervals along the longitudinal direction.

As shown in FIG. 1, the cross-sectional configuration of the front pillar reinforcing member 44 as seen from the longitudinal direction is a rectangular pipe shape, and forms a closed cross-section Through-holes 51 for passage of the fastening members 48 are formed respectively in an outer wall portion 44B and an inner wall portion 44C of the front pillar reinforcing member 44. Further, through-holes 52, 54 for passage of the fastening members 48 are formed respectively in the inner wall portion 18A of the front pillar inner 18 and a front portion 28A of the front pillar inner reinforcement 28 which the outer wall portion 44B of the front pillar reinforcing member 44 overlaps.

Accordingly, the front pillar reinforcing member 44 is fixed by the fastening members 48 to the front pillar inner 18 and the front pillar inner reinforcement 28.

Note that, in FIG. 1, reference numeral 58 denotes a bolt which structures a portion of the fastening member 48, and reference numeral 59 denotes an air bag device.

In the present exemplary embodiment, the front pillar reinforcing member 44, which extends along the front pillar 14 in the vehicle up-down direction, is provided between the front pillar 14, which is disposed at each of the vehicle transverse direction end portions of the front portion of the vehicle cabin 12 such that the longitudinal direction thereof runs along the vehicle up-down direction and which is a closed cross-section running along the vehicle up-down direction, and the front pillar garnish 40, which is provided at the vehicle cabin 12 side of the front pillar 14 and covers the front pillar 14. Therefore, the cross-sectional secondary moment of the front pillar portion 10A greatly increases due to the closed cross-section 20 of the front pillar 14 and the closed cross-section 45 of the front pillar reinforcing member 44. As a result, the rigidity and strength of the front pillar portion 10A of the vehicle body 10 are ensured without making the closed cross-section 20 of the front pillar 14 large.

Thus, when a load (arrow F1 in FIG. 6) is applied to the front pillar portion 10A of the vehicle body 10 at the time when the vehicle rolls-over or the like, deformation of the front pillar portion 10A (bending deformation toward the vehicle rear side) can be suppressed.

The load applied at the time when the vehicle rolls-over fluctuates in accordance with changes in the vehicle weight which arise due to differences in the operator cab (single cab or double cab) and the engine (the engine capacity or the like). In the present exemplary embodiment, the front pillar reinforcing member 44 is fixed to the front pillar 14 by the fastening members 48. Therefore, the front pillar reinforcing members 44 having different strengths can easily be mounted to standardized front pillars 14 in accordance with the vehicle weight.

In the present exemplary embodiment, the front pillar reinforcing member 44 is provided at the vehicle front side (the side near the front windowshield glass 30) between the front pillar 14 and the front pillar garnish 40. Therefore, an interval M1 along the vehicle longitudinal direction between the front pillar reinforcing member 44 and a vehicle occupant S who is seated in an unillustrated front seat becomes wider. As a result, if the vehicle occupant S who is seated in the front seat moves toward the front of the vehicle (in the direction of arrow A in FIG. 1) relative to the vehicle body at the time of a vehicle collision or the like, there is no likelihood that the vehicle occupant S hits the front pillar reinforcing member 44 since the front pillar garnish 40 is interposed therebetween.

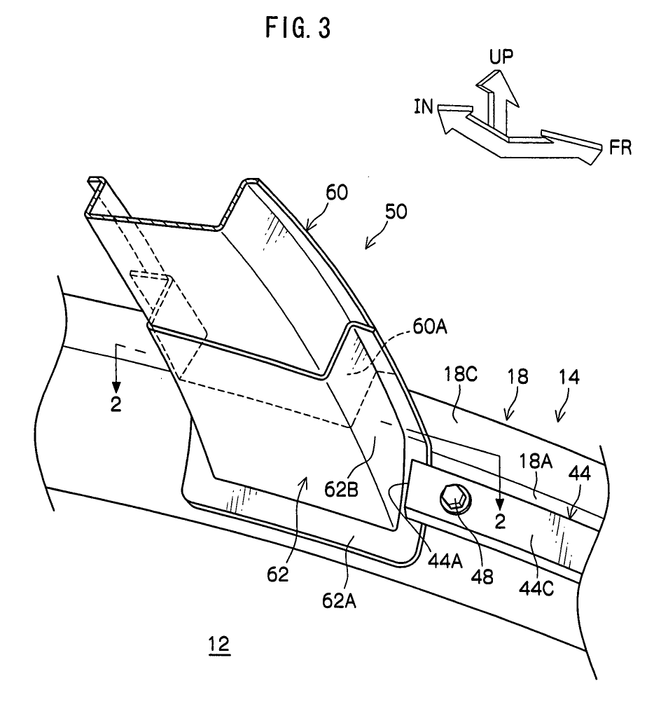

The joined portion of the front roof header 50 and the front pillar 14 is shown in FIG. 3 in a perspective view seen obliquely from the front and the vehicle transverse direction inner side.

As shown in FIG. 3, the front roof header 50 is disposed at the top portion of the front end of the vehicle cabin 12, such that the longitudinal direction thereof runs along the vehicle transverse direction. Both vehicle transverse direction end portions of the front roof header 50 are joined to the front pillars 14. A vehicle transverse direction outer side end portion 60A of a front roof header lower 60, which structures the lower portion of the front roof header 50, is joined by welding or the like to a roof header extension 62. More specifically, the cross-sectional configuration of the front roof header lower 60 as seen from the vehicle transverse direction is a hat-shaped cross-sectional configuration, and the cross-sectional configuration of the roof header extension 62 as seen from the vehicle transverse direction also is a hat-shaped cross-sectional configuration. The vehicle transverse direction outer side end portion 60A of the front roof header lower 60 is joined by welding or the like to the roof header extension 62 in a state in which the vehicle transverse direction outer side end portion 60A is inserted from the vehicle upper side into the hat-shaped cross-section of the roof header extension 62. Further, a flange 62A is formed at the peripheral edge portion of the vehicle transverse direction end portion of the roof header extension 62, toward the outer side of the roof header extension 62.

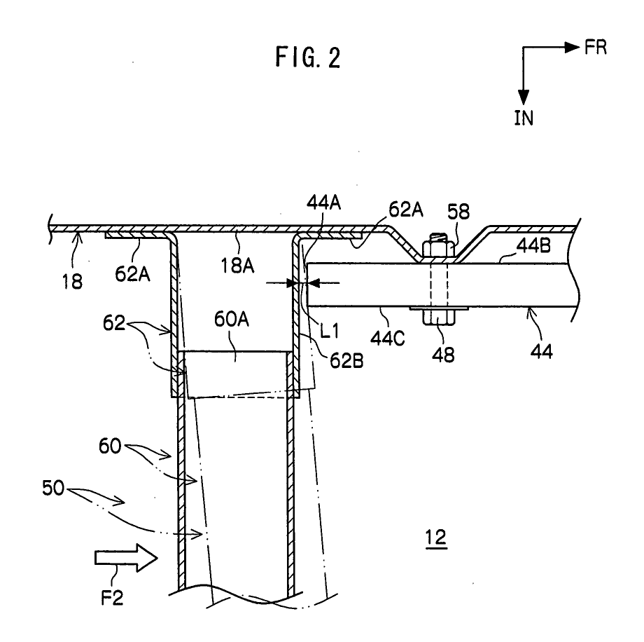

FIG. 2 is an enlarged cross-sectional view along cross-section line 2-2 of FIG. 3.

The flange 62A of the roof header extension 62 is joined by welding or the like to the vehicle transverse direction inner side surface of the inner wall portion 18A of the front pillar inner 18. Further, the upper end portion 44A of the front pillar reinforcing member 44 and a front wall portion 62B of the roof header extension 62 are close to one another, and a distance L1 between the upper end portion 44A of the front pillar reinforcing member 44 and the front wall portion 62B of the roof header extension 62 is small. Namely, the distance L1 between the upper end portion 44A of the front pillar reinforcing member 44 and the front wall portion 62B of the roof header extension 62 is set to the minimum value which takes into consideration errors in welding, errors in assembly, and the like.

Accordingly, in the present exemplary embodiment, the upper end portions 44A of the front pillar reinforcing members 44 and the front wall portions 62B of the roof header extensions 62, which structure the vehicle transverse direction both end portions of the front roof header 50 which connects the upper end portions of the left and right front pillars 14 to one another, are disposed near to one another.

Therefore, when the front roof header 50 deforms toward the rear of the vehicle as shown by the two-dot chain line in FIG. 1 due to load (arrow F2 in FIG. 2) which is applied to the front roof header 50 at the time when the vehicle rolls-over or the like, the front wall portions 62B of the roof header extensions 62 hit the upper end portions 44A of the front pillar reinforcing members 44. Therefore, deformation of the front roof header 50 toward the rear of the vehicle can be suppressed.

Further, the load F2 which is applied to the front roof header 50 is efficiently transmitted to the front pillar reinforcing members 44, and is efficiently transmitted to the front pillars 14 as well. As a result, deformation of the front roof header 50 and of the vehicle body overall, which arises at the time when the vehicle rolls-over or the like, can be suppressed.

Operation of the present exemplary embodiment will be described next.

In the present exemplary embodiment, the front pillars 14, which are formed as closed cross-sections along the vehicle up-down direction, are disposed at the both vehicle transverse direction end portions of the front portion of the vehicle cabin 12 such that the longitudinal directions of the front pillars 14 run along the vehicle up-down direction. Further, the front pillar reinforcing members 44, which extend in the vehicle up-down direction, are provided along the front pillars 14, between the front pillars 14 and the front pillar garnishes 40 which are provided at the vehicle cabin 12 sides of the front pillars 14. Therefore, the cross-sectional secondary moments of the front pillar portions 10A are greatly increased due to the closed cross-sections 20 of the front pillars 14 and the closed cross-sections 45 of the front pillar reinforcing members 44.

As a result, the rigidity and strength of the front pillar portion 10A are ensured without making the closed cross-section 20 of the front pillar 14 large. Therefore, when load (arrow F1 in FIG. 6) is applied to the front pillar portion 10A at the time when the vehicle rolls-over or the like, deformation of the front pillar portion 10A (bending deformation toward the rear of the vehicle) can be suppressed. Further, deformation of the vehicle as a whole also can be suppressed.

Further, the load which is applied at the time when the vehicle rolls-over fluctuates in accordance with changes in the vehicle weight which arise due to differences in the operator cab (single cab or double cab) and the engine (the engine capacity or the like). However, in the present exemplary embodiment, the front pillar reinforcing member 44 is fixed to the front pillar 14 by the fastening members 48. Therefore, the front pillar reinforcing members 44 having different strengths can easily be mounted to standardized front pillars 14 in accordance with the vehicle weight. As a result, standardization of the front pillars 14 is easy.

Further, in the present exemplary embodiment, the front pillar reinforcing member 44 is provided at the vehicle front side (the side near the front windshield glass 30) between the front pillar 14 and the front pillar garnish 40. Thus, the spacing M1 along the vehicle longitudinal direction between the front pillar reinforcing member 44 and the vehicle occupant S seated in an unillustrated front seat is increased. As a result, when the vehicle occupant S who is seated in the front seat moves toward the front of the vehicle (in the direction of arrow A in FIG. 1) relative to the vehicle body at the time of a vehicle collision or the like, there is no likelihood that the vehicle occupant S hits the front pillar reinforcing member 44 since the front pillar garnish 40 is interposed therebetween.

Moreover, in the present exemplary embodiment, the upper end portions 44A of the front pillar reinforcing members 44 and the front wall portions 62B of the roof header extensions 62, which structure the both vehicle transverse direction end portions of the front roof header 50 which connects the upper end portions of the left and right front pillars 14 together, are disposed so as to be close to one another.

Thus, when the front roof header 50 deforms toward the rear of the vehicle as shown by the two-dot chain line in FIG. 1 due to load (arrow F2 in FIG. 2) applied to the front roof header 50 at the time when the vehicle rolls-over or the like, the front wall portions 62B of the roof header extensions 62 contact the upper end portions 44A of the front pillar reinforcing members 44. Consequently, deformation of the front roof header 50 toward the rear of the vehicle can be suppressed.

Further, the load F2 which is applied to the front roof header 50 is efficiently transmitted to the front pillar reinforcing members 44, and is efficiently transmitted to the front pillars 14 as well. Thus, deformation of the front roof header 50 and of the vehicle body overall, which arises at the time when the vehicle rolls-over or the like, can be suppressed.

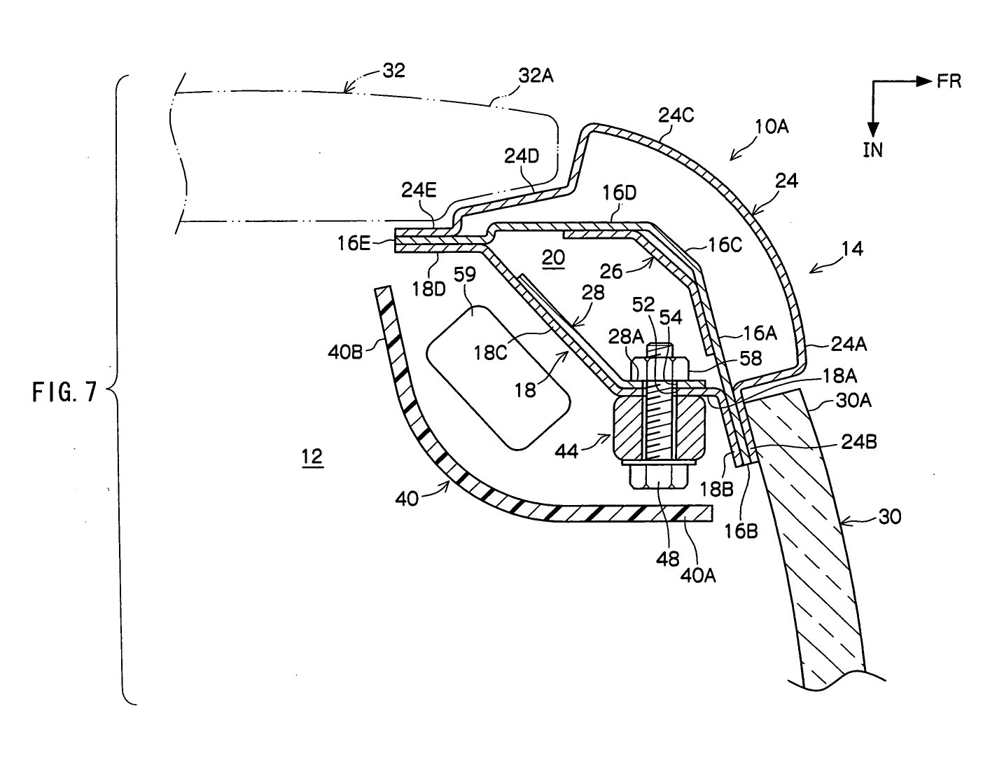

A vehicle body structure in accordance with a second exemplary embodiment of the present invention will be described next with reference to FIG. 7.

Note that members which are the same as those of the first exemplary embodiment are denoted by the same reference numerals, and description thereof is omitted.

The vehicle body structure of the second exemplary embodiment is illustrated in FIG. 7 in a cross-sectional view which corresponds to FIG. 1.

As shown in FIG. 7, in the present exemplary embodiment, the front pillar reinforcing member 44 is structured by a rod member whose cross-sectional configuration as seen from the longitudinal direction is rectangular.

Accordingly, operation and effects which are similar to those of the first exemplary embodiment are obtained by the present exemplary embodiment as well.

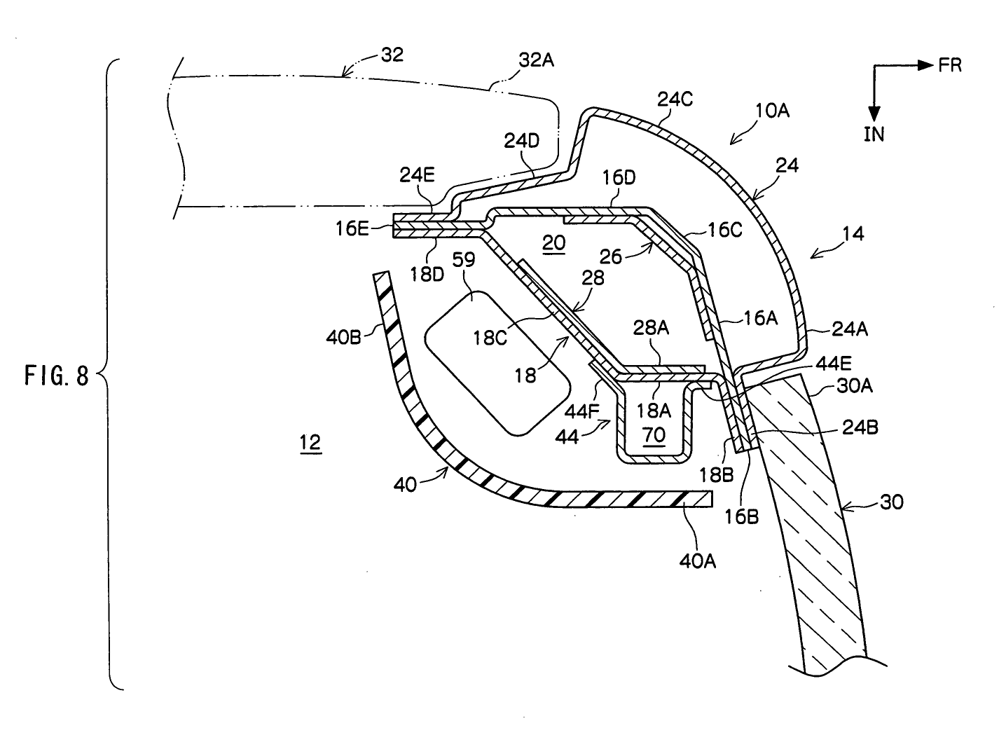

A vehicle body structure in accordance with a third exemplary embodiment of the present invention will be described next with reference to FIG. 8.

Note that members which are the same as those of the first exemplary embodiment are denoted by the same reference numerals, and description thereof is omitted.

The vehicle body structure of the third exemplary embodiment is illustrated in FIG. 8 in a cross-sectional view which corresponds to FIG. 1.

As shown in FIG. 8, in the present exemplary embodiment, the front pillar reinforcing member 44 is structured by a pressed part whose cross-sectional configuration as seen from the longitudinal direction is a substantially hat-shaped cross-section. Further, a flange 44E at the vehicle front side of the front pillar reinforcing member 44 is joined by welding or the like to the vehicle transverse direction inner side surface of the inner wall portion 18A of the front pillar inner 18. A flange 44F at the vehicle rear side of the front pillar reinforcing member 44 is joined by welding or the like to the vehicle transverse direction inner side surface of the inclined portion 18C of the front pillar inner 18. Therefore, the front pillar reinforcing member 44, together with the front pillar inner 18, forms a closed cross-section 70 whose cross-sectional configuration as seen from the longitudinal direction is rectangular.

Accordingly, operation and effects which are similar to those of the first exemplary embodiment are obtained by the present exemplary embodiment as well.

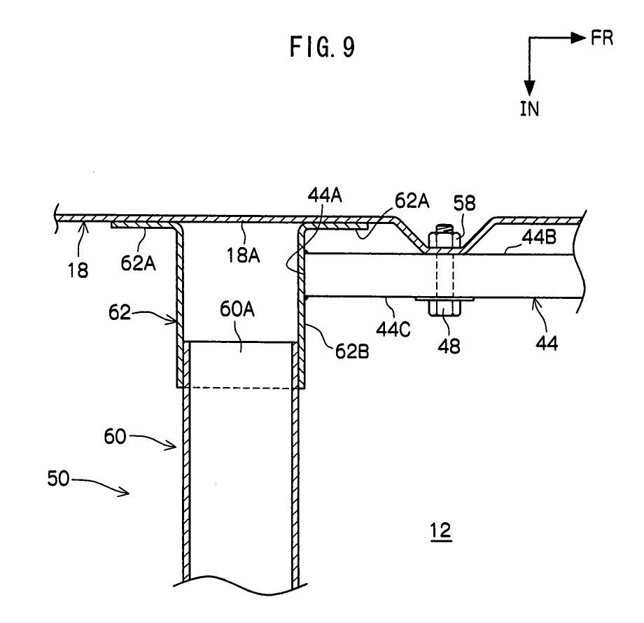

A vehicle body structure in accordance with a fourth exemplary embodiment of the present invention will be described next with reference to FIG. 9.

Note that members which are the same as those of the first exemplary embodiment are denoted by the same reference numerals, and description thereof is omitted.

The vehicle body structure of the fourth exemplary embodiment is illustrated in FIG. 9 in a cross-sectional view which corresponds to FIG. 2.

As shown in FIG. 9, in the present exemplary embodiment, the upper end portion 44A of the front pillar reinforcing member 44 is joined by welding or the like to the front surface of the front wall portion 62B of the roof header extension 62.

Accordingly, operation and effects which are similar to those of the first exemplary embodiment are obtained by the present exemplary embodiment as well.

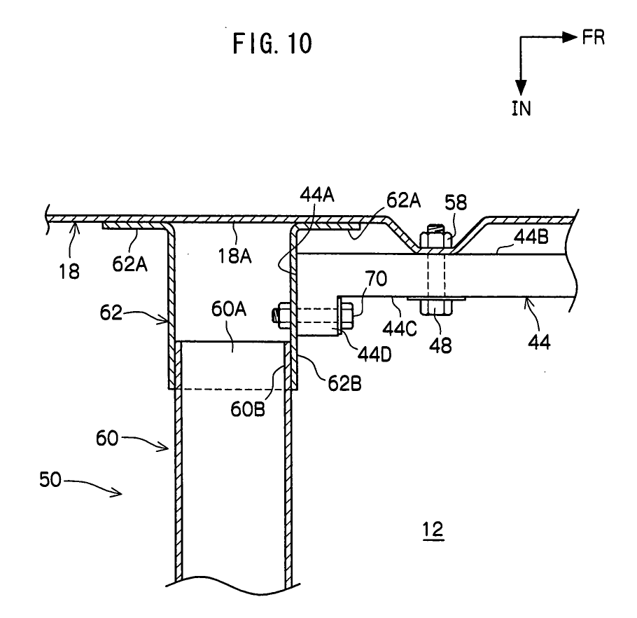

A vehicle body structure in accordance with a fifth exemplary embodiment of the present invention will be described next with reference to FIG. 10.

Note that members which are the same as those of the first exemplary embodiment are denoted by the same reference numerals, and description thereof is omitted.

The vehicle body structure of the fifth exemplary embodiment is illustrated in FIG. 10 in a cross-sectional view which corresponds to FIG. 2.

As shown in FIG. 10, in the present exemplary embodiment, the upper end portion 44A of the front pillar reinforcing member 44 is bent toward the vehicle transverse direction inner side such that a mounting portion 44D is formed. Further, the mounting portion 44D of the front pillar reinforcing member 44 is fixed to the front wall portion 62B of the roof header extension 62 by a fastening member 70 such as a bolt or the like.

Note that the mounting portion 44D of the front pillar reinforcing member 44 may be fixed by the fastening member 70 such as a bolt or the like to the overlapping portion of the front wall portion 62B of the roof header extension 62 and a front wall portion 60B of the front roof header lower 60.

Accordingly, operation and effects which are similar to those of the first exemplary embodiment are obtained by the present exemplary embodiment as well.

The present invention is described in detail above with respect to specific embodiments, but the present invention is not limited to the above-described respective exemplary embodiments, and it will be clear to those skilled in the art that various other embodiments are possible within the scope of the present invention. For example, in the above respective exemplary embodiments, the cross-sectional configuration, as seen from the longitudinal direction, of the front pillar reinforcing member 44 which serves as the reinforcing member is a rectangular pipe shaped, a rectangular, or a substantially hat-shaped cross-sectional configuration. However, the cross-sectional configuration of the reinforcing member as seen from the longitudinal direction may be another shape such as the shape of a round pipe or the like.

Further, in the above-described respective exemplary embodiments, the vehicle transverse direction outer side end portion 60A of the front roof header lower 60 is joined to the roof header extension 62. However, the front roof header lower 60 and the roof header extension 62 may be structured as a single part.

What is claimed is:

1. A vehicle body structure comprising:
a front pillar disposed at each of both vehicle transverse direction end portions of a vehicle cabin front portion such that a longitudinal direction of the front pillar runs along a vehicle up-down direction, a cross-section of the front pillar in a direction orthogonal to the longitudinal direction being a closed cross-section;
a pillar garnish provided at a vehicle cabin inner side of the front pillar, and covering the front pillar; and
a reinforcing member provided between the front pillar and the pillar garnish, and extending in the vehicle up-down direction along the front pillar.

2. The vehicle body structure of claim 1, wherein the reinforcing member is provided at a side near a front windshield glass, between the front pillar and the pillar garnish.

3. The vehicle body structure of claim 1, wherein a cross-section, as seen from a longitudinal direction, of the reinforcing member forms a closed cross-section.

4. The vehicle body structure of claim 2, wherein a cross-section, as seen from a longitudinal direction, of the reinforcing member forms a closed cross-section.

5. The vehicle body structure of claim 1, further comprising a front roof header which is disposed at an upper end portion of the vehicle cabin front portion such that a longitudinal direction of the front roof header runs along a vehicle transverse direction, and which connects upper end portions of the left and right front pillars together, wherein upper ends of the reinforcing members are one of joined to and disposed near to both vehicle transverse direction end portions of the front roof header.

6. The vehicle body structure of claim 2, further comprising a front roof header which is disposed at an upper end portion of the vehicle cabin front portion such that a longitudinal direction of the front roof header runs along a vehicle transverse direction, and which connects upper end portions of the left and right front pillars together, wherein upper ends of the reinforcing members are one of joined to and disposed near to both vehicle transverse direction end portions of the front roof header.

7. The vehicle body structure of claim 3, further comprising a front roof header which is disposed at an upper end portion of the vehicle cabin front portion such that a longitudinal direction of the front roof header runs along a vehicle transverse direction, and which connects upper end portions of the left and right front pillars together, wherein upper ends of the reinforcing members are one of joined to and disposed near to both vehicle transverse direction end portions of the front roof header.

8. The vehicle body structure of claim 4, further comprising a front roof header which is disposed at an upper end portion of the vehicle cabin front portion such that a longitudinal direction of the front roof header runs along a vehicle transverse direction, and which connects upper end portions of the left and right front pillars together, wherein upper ends of the reinforcing members are one of joined to and disposed near to both vehicle transverse direction end portions of the front roof header.

9. The vehicle body structure of claim 1, wherein the reinforcing member is structured by a pressed part whose cross-sectional configuration as seen from a longitudinal direction is a substantially hat-shaped cross-sectional configuration.

10. The vehicle body structure of claim 2, wherein the reinforcing member is structured by a pressed part whose cross-sectional configuration as seen from a longitudinal direction is a substantially hat-shaped cross-sectional configuration.

11. The vehicle body structure of claim 3, wherein the reinforcing member is structured by a pressed part whose cross-sectional configuration as seen from a longitudinal direction is a substantially hat-shaped cross-sectional configuration.

12. The vehicle body structure of claim 4, wherein the reinforcing member is structured by a pressed part whose cross-sectional configuration as seen from a longitudinal direction is a substantially hat-shaped cross-sectional configuration.

13. The vehicle body structure of claim 5, wherein the reinforcing member is structured by a pressed part whose cross-sectional configuration as seen from a longitudinal direction is a substantially hat-shaped cross-sectional configuration.

14. The vehicle body structure of claim 6, wherein the reinforcing member is structured by a pressed part whose cross-sectional configuration as seen from a longitudinal direction is a substantially hat-shaped cross-sectional configuration.

15. The vehicle body structure of claim 7, wherein the reinforcing member is structured by a pressed part whose cross-sectional configuration as seen from a longitudinal direction is a substantially hat-shaped cross-sectional configuration.

16. The vehicle body structure of claim 8, wherein the reinforcing member is structured by a pressed part whose cross-sectional configuration as seen from a longitudinal direction is a substantially hat-shaped cross-sectional configuration.
